(19) United States
(12) Patent Application Publication
(10) Pub. No.: US 2025/0155259 A1
(43) Pub. Date: May 15, 2025

(54) CROWDEDNESS DEGREE SEARCH SYSTEM

(71) Applicant: NTT DOCOMO, INC., Tokyo (JP)

(72) Inventors: Yusuke NAKAMURA, Chiyoda-ku (JP); Takashi SUZUKI, Chiyoda-ku (JP); Akira YAMADA, Chiyoda-ku (JP)

(73) Assignee: NTT DOCOMO, INC., Tokyo (JP)

(21) Appl. No.: 18/837,698

(22) PCT Filed: Feb. 8, 2023
(86) PCT No.: PCT/JP2023/004261

§ 371 Date: Aug. 12, 2024

(30) Foreign Application Priority Data
Apr. 18, 2022 (JP) 2022-068125

(51) Int. Cl. G01C 21/36; G06Q 10/04

(52) U.S. Cl. CPC G01C 21/3691; G06Q 10/04

(57) ABSTRACT

A congestion degree search system is a system that searches for, for a target of a degree of congestion that is a location or a transportation means, a degree of congestion of the target when people change their behavior in response to information according to the degree of congestion being presented, and includes: an estimation unit that estimates the degree of congestion of the target under conditions in which information according to the degree of congestion set in advance for the target is presented to people who act; and a search unit that sets a degree of congestion used in estimation, causes the estimation unit to repeatedly estimate the degree of congestion, and searches for the degree of congestion of the target so that the difference between the degree of congestion used in the estimation and the estimated degree of congestion decreases.

### TECHNICAL FIELD

The present invention relates to a congestion degree search system that searches for the degree of congestion of a congestion degree calculation target when people change their behavior in response to information according to the degree of congestion being presented.

### BACKGROUND ART

Patent Literature 1 describes predicting congestion in a predetermined location based on people's planned behavior.

### CITATION LIST

### Patent Literature

Patent Literature 1: Japanese Unexamined Patent Publication No. 2019-49765

### SUMMARY OF INVENTION

### Technical Problem

Conventionally, as shown in Patent Literature 1, it has been proposed to predict congestion in a given location. However, publishing the predicted value of congestion may result in incorrect prediction. For example, a person who knows that a location as a destination is crowded or is expected to be crowded may change the destination because the person hates congestion. When the number of people who know the predicted value of congestion is infinitesimally small compared to the population, the impact of people changing their behavior is small. However, when the number of people who change their behavior is too large to be ignored, the congestion predicted by the conventional method may not be accurate.

An embodiment of the present invention has been made in consideration of the above, and it is an object of the present invention to provide a congestion degree calculation system capable of searching for the appropriate degree of congestion when people to whom information according to the degree of congestion is presented change their behavior.

### Solution to Problem

In order to achieve the above-mentioned object, a congestion degree search system according to one embodiment of the present invention is a congestion degree search system for searching for, for a target of a degree of congestion that is a location or a transportation means, a degree of congestion of the target when people change their behavior in response to information according to a degree of congestion being presented, and includes an estimation unit that estimates the degree of congestion of the target under conditions in which information according to a degree of congestion set in advance for the target is presented to people who act, and a search unit that sets a degree of congestion used in estimation by the estimation unit, causes the estimation unit to repeatedly estimate the degree of congestion, and searches for the degree of congestion of the target so that a difference between the degree of congestion used in the estimation by the estimation unit and the degree of congestion estimated by the estimation unit decreases.

In the congestion degree search system according to one embodiment of the present invention, a degree of congestion is estimated under conditions in which information according to a degree of congestion is presented to people who act, and the degree of congestion is searched so that a difference between the degree of congestion used in the estimation and the estimated degree of congestion. Therefore, according to the congestion degree search system of one embodiment of the present invention, it is possible to search for the appropriate degree of congestion when people to whom information according to the degree of congestion is presented change their behavior.

### Advantageous Effects of Invention

According to an embodiment of the present invention, it is possible to search for the appropriate degree of congestion when people to whom information according to the degree of congestion is presented change their behavior.

### BRIEF DESCRIPTION OF DRAWINGS

FIG. 1 is a diagram showing the configuration of a congestion degree search system according to an embodiment of the present invention.

FIG. 2 is a diagram schematically showing a multi-agent simulation.

FIG. 3 is a table showing an example of information on simulation target people, which is information necessary for a simulation.

FIG. 4 is a diagram showing an overview of a search for the degree of congestion.

FIG. 5 is a graph showing an image of setting the next pre-predicted value using a gradient method.

FIG. 6 is a diagram showing a specific example of the search for the degree of congestion.

FIG. 7 is a flowchart showing a process performed by the congestion degree search system according to the embodiment of the present invention.

FIG. 8 is a diagram showing the hardware configuration of the congestion degree search system according to the embodiment of the present invention.

### DESCRIPTION OF EMBODIMENTS

Hereinafter, an embodiment of a congestion degree search system according to the present invention will be described in detail with reference to the diagrams. In addition, in the description of the diagrams, the same elements are denoted by the same reference numerals, and repeated description thereof will be omitted.

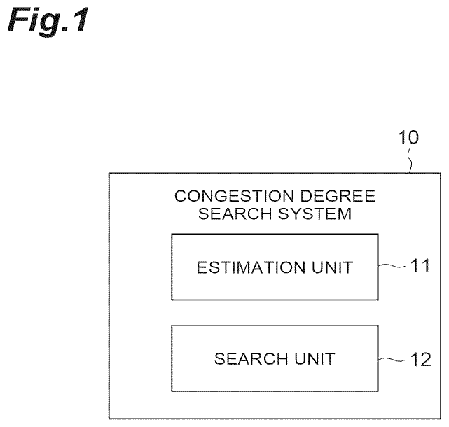

FIG. 1 shows a congestion degree search system 10 according to the present embodiment. The congestion degree search system 10 is a system (apparatus) that searches for the degree of congestion of a congestion degree target, which is a location or a transportation means, when people change their behavior in response to information according to the degree of congestion being presented.

Conventionally, the degree of congestion at the geographical location of a facility or the like or in a transportation means has been measured or predicted. A person who acts may change their behavior by referring to information according to the measured or predicted degree of congestion. For example, a person who knows that a location as a destination is crowded or is expected to be crowded may change the destination because the person hates congestion. In the present embodiment, “people to whom information according to the degree of congestion is presented change their behavior” is referred to as a behavior change. The behavior change is, for example, changing the destination as described above. In addition, the behavior change may be a change other than the destination change.

When the number of people to whom information according to the degree of congestion is presented is infinitesimally small compared to the population, the impact of people's behavior changes is small. However, when the number of people who change their behavior is too large to be ignored, the measured or predicted degree of congestion may change due to the people's behavior changes and may not be accurate.

The congestion degree search system 10 searches for a highly accurate predicted value of the degree of congestion under the conditions in which information according to the degree of congestion is presented to people who act. The searched degree of congestion can be used for any purpose, such as being presented to people who act.

The congestion degree search system 10 is configured by a computer such as a PC (personal computer) or a server device. The congestion degree search system 10 may be configured by a plurality of computers. The congestion degree search system 10 may be able to transmit and receive information to and from other devices through a network in order to acquire information necessary to realize functions.

Subsequently, the functions of the congestion degree search system 10 according to the present embodiment will be described. As shown in FIG. 1, the congestion degree search system 10 includes an estimation unit 11 and a search unit 12.

The estimation unit 11 is a functional unit that estimates the degree of congestion of a target under the conditions in which information according to the degree of congestion set in advance for the target is presented to people who act. The estimation unit 11 may estimate the degree of congestion of a target by simulating the people's behavior under the conditions in which information according to the degree of congestion set in advance for the target is presented to people who act. The estimation unit 11 may simulate the behavior of each person under the conditions in which information according to the degree of congestion set in advance for the target is presented to people who act.

The target of the estimated degree of congestion is a location or a transportation means set in advance. The location is the geographic location of a facility or the like. The transportation means is a public transportation means such as buses or trains. The degree of congestion of the transportation means is, for example, the degree of congestion of passengers in the transportation means. The degree of congestion may be estimated for a plurality of targets. The information according to the degree of congestion presented to people who act is, for example, information indicating the degree of congestion itself of the target (for example, the number of people at the target location or the number of people riding on the target transportation means). Alternatively, the information may be information related to the degree of congestion, for example, the travel time, waiting time, presence or absence of delay, or duration of the delay of the transportation means caused by congestion.

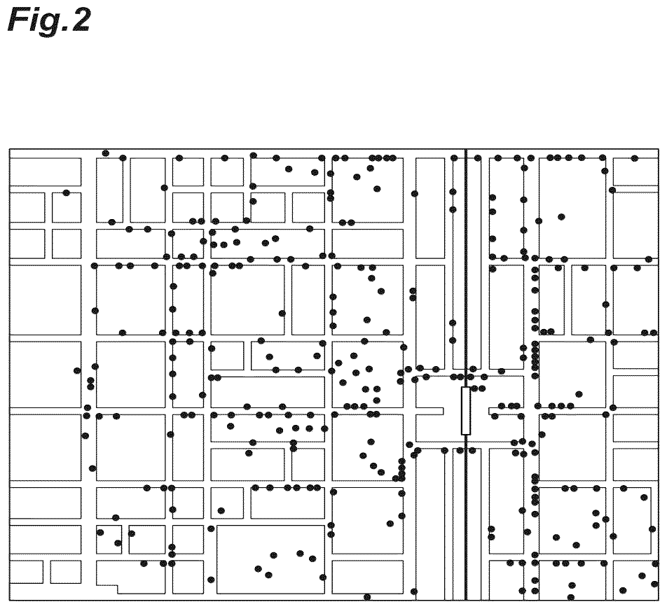

For example, the estimation unit 11 estimates the degree of congestion as follows. The estimation unit 11 estimates the degree of congestion by simulating people's behavior. The estimation unit 11 performs a multi-agent simulation in the people's behavior area. The multi-agent simulation is to reproduce the behavior of each person at each time by imitating the real world. FIG. 2 schematically shows a multi-agent simulation. In the multi-agent simulation, the movement status of people (agents) in the people's behavior area, such as an urban area, is calculated. In FIG. 2, each point represents an individual person (person's location). In the multi-agent simulation, a situation in which people use a transportation means such as buses or trains is also calculated.

The estimation unit 11 performs a simulation taking into account the behavior of a simulation target person when information according to the target degree of congestion is presented to the person, that is, a behavior change. For example, the simulation may include a decision-making model according to the behavior change. The decision-making model is, for example, to change the destination by changing behavior according to a probability p (degree of congestion) (change rate, behavior change rate) according to the presented degree of congestion. That is, p % of people who see the information indicating the degree of congestion will change their behavior.

Alternatively, the decision-making model is to calculate a value f for each location, which can be a destination, using the following Equation to make a movement to the location with the largest value f.

f=w_{degree of congestion}×degree of congestion+w_{attractiveness}×attractiveness+w_{incentive}×incentive

In the above Equation, the degree of congestion is a value indicating the degree of congestion at the location. The attractiveness is a value indicating the attractiveness of the location. The incentive is a value indicating the incentive to go to the location. w_{degree} of congestion, w_{attractiveness}, and w_{incentive} are weights of the respective values, and are values set in advance. In the above Equation, as the degree of congestion, a value according to the target degree of congestion presented to the simulation target person is used. The attractiveness and the incentive are values that are set in advance for each location or in a simulation.

The above decision-making model is set in advance by an existing method or the like. For example, this is set through know-how of decision-making models, questionnaires, or demonstration experiments. In addition, in the simulation, consideration of behavior changes when information according to the degree of congestion is presented may be performed using any method other than the above decision-making model.

By using a multi-agent simulation, it is possible to estimate the degree of congestion (dynamic congestion) in a realistic situation. In addition, the simulation by the estimation unit 11 does not need to be a multi-agent simulation, and may be any simulation as long as it is possible to simulate people's behavior under the conditions in which information according to the degree of congestion set in advance for the target is presented.

In addition, the target (location or transportation means) of the estimated degree of congestion is the same as the target for which information according to the degree of congestion is presented. In addition, the number of targets may be plural.

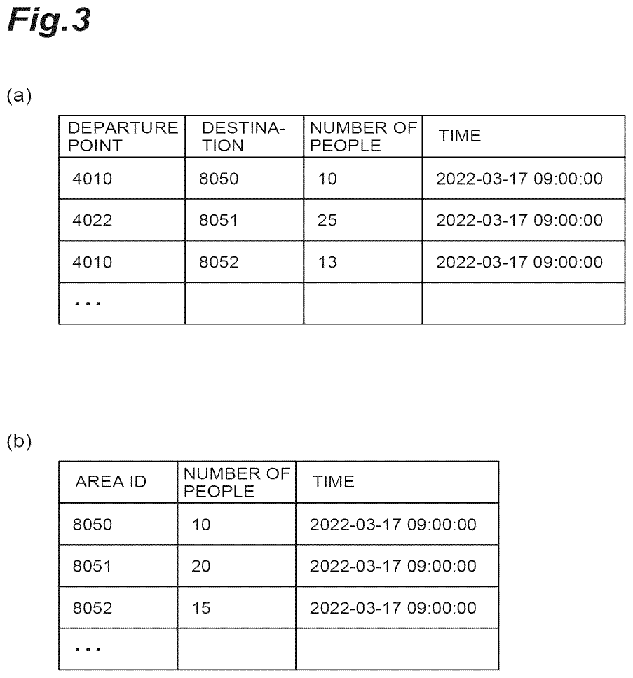

The estimation unit 11 acquires information necessary for the simulation. The estimation unit 11 acquires information on the simulation target person as information necessary for the simulation. Specifically, the estimation unit 11 acquires OD (Origin-Destination) data indicating when, from where, to where, and how many people move. FIG. 3(a) shows an example of the OD data. The OD data is, for example, data in which a departure point, a destination, the number of people, and a time (departure time) are associated with each other. In the example shown in FIG. 3(a), the departure point and the destination of the OD data are identifiers (area IDs) indicating small areas (for example, mesh-shaped areas) where the people's behavior area is divided, which are the departure point and destination. The number of people in the OD data indicates the number of people moving. The time in the OD data indicates the departure time of the movement. Data in the first row of FIG. 3(a) indicates that 10 people depart from a small area “4010” and move to a small area “8050” as a destination starting at 9:00 a.m. on Mar. 17, 2022. In addition, the OD data may also include information (for example, the time of arrival at the destination) other than the above.

The OD data may be generated based on the locations and movements of real people. For example, time-series location information indicating when, where, and how many people are present is obtained from mobile terminals carried by people and various sensors such as sensors that measure traffic volume. FIG. 3(b) shows an example of a location information database that stores this location information. The location information is, for example, information in which an area ID, the number of people, and a time are associated with each other. The area ID of the location information is an identifier indicating a small area (for example, a mesh-shaped area) where the people's behavior area is divided. The number of people and the time of the location information indicate the number of people and the time in the small area indicated by the corresponding area ID. Data in the first row of FIG. 3(b) indicates that 10 people are present in the small area “8050” at 9:00 a.m. on Mar. 17, 2022. The OD data may be generated from the above location information by using known data assimilation techniques.

The estimation unit 11 may read and acquire the OD data from a database in which the OD data is stored in advance, or may generate and acquire the OD data by reading the data from a database in which data with which the OD data can be generated is stored in advance. The estimation unit 11 may acquire the OD data using any other method. The estimation unit 11 may acquire information necessary for the simulation other than the above information, in addition to the above information or instead of the above information.

The estimation unit 11 performs a simulation using the degree of congestion (pre-predicted value) set by the search unit 12 as described below as the degree of congestion related to the information to be presented to the simulation target person. The simulation may be performed, for example, by using existing software for performing a multi-agent simulation.

The estimation unit 11 acquires an estimated value (post-predicted value) of the degree of congestion for the target (location or transportation means) from the simulation results. For example, the estimation unit 11 performs a simulation for a predetermined period of time (for example, 30 minutes) in the simulation, and sets the number of people present in the target at the end of the simulation as an estimated value (post-predicted value) of the degree of congestion. In addition, the degree of congestion does not have to be the number of people present at the target, and may be anything indicating the degree of congestion at the target. The estimation unit 11 outputs information indicating the estimation result for the degree of congestion of the target to the search unit 12. In addition, the estimation of the degree of congestion is performed repeatedly as described below.

In addition, the estimation unit 11 may estimate the degree of congestion of the target using a method other than simulation. For example, if a model for estimating the degree of congestion can be simplified and an estimated value (post-predicted value) of the degree of congestion can be calculated (estimated) based on the congestion degree (pre-predicted value) set by the search unit 12 using a mathematical solution set in advance, this may be used.

The search unit 12 is a functional unit that sets the degree of congestion used in the estimation by the estimation unit 11, causes the estimation unit 11 to repeatedly estimate the degree of congestion, and searches for the degree of congestion of the target so that the difference between the degree of congestion used in the estimation by the estimation unit 11 and the degree of congestion estimated by the estimation unit 11 decreases. The search unit 12 may set the degree of congestion used in the next estimation by the estimation unit 11 by using an optimization method using an evaluation function based on the degree of congestion used for the estimation by the estimation unit 11 and the degree of congestion estimated by the estimation unit 11.

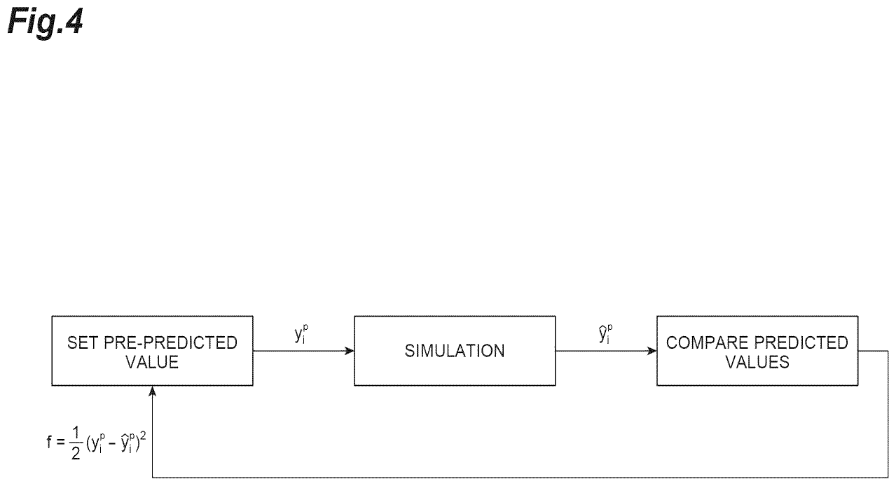

For example, the search unit 12 searches for the degree of congestion as follows. FIG. 4 shows an overview of the search for the degree of congestion by the search unit 12. The search unit 12 sets a pre-predicted value y^{p}ᵢ that is the degree of congestion for the target and is used for estimation by the estimation unit 11. i is an index indicating the location or transportation means that is the target of the degree of congestion. As described above, the pre-predicted value y^{p}ᵢ may be set for a plurality of targets. The search unit 12 notifies the estimation unit 11 of the set pre-predicted value y^{p}ᵢ. The estimation unit 11 estimates a post-predicted value y\hat{ }^{p}ᵢ (note that “\hat{ }” is placed directly above “y”; the same hereinbelow), which is an estimated value of the degree of congestion for the target, by performing a simulation using the notified pre-predicted value y^{p}ᵢ. The estimation unit 11 outputs the post-predicted value y\hat{ }^{p}ᵢ, which is an estimation result, to the search unit 12.

The search unit 12 determines whether or not to end the search by comparing the set pre-predicted value y^{p}ᵢ; with the post-predicted value y\hat{ }^{p}ᵢ input from the estimation unit 11. When it is determined that the search is to be ended, the search unit 12 outputs a final predicted value y^{p}_{fin}, which is the degree of congestion of the search result based on at least one of the pre-predicted value y^{p}ᵢ and the post-predicted value y\hat{ }^{p}ᵢ. For example, the search unit 12 sets the final predicted value y^{p}_{fin}=the pre-predicted value y^{p}ᵢ. When the search unit 12 determines that the search is to be ended, if it is determined that the search is not ended, the search unit 12 sets a new pre-predicted value y^{p}ᵢ to repeat the above process.

Hereinafter, the above search for the degree of congestion will be specifically described. First, the search unit 12 sets an initial pre-predicted value y^{p}ᵢ. For example, without setting the pre-predicted value y^{p}ᵢ, that is, under the conditions in which information according to the degree of congestion is not presented to people who act, the search unit 12 causes the estimation unit 11 to estimate the degree of congestion of the target and sets the degree of congestion obtained as estimation results as the initial pre-predicted value y^{p}ᵢ. Alternatively, the search unit 12 estimates the degree of congestion of the target using a method other than the simulation by the estimation unit 11, and sets the degree of congestion obtained as estimation results as the initial pre-predicted value y^{p}ᵢ. The method other than the above simulation may be any conventional method, for example, a method using a learning model such as an RNN (recurrent neural network) generated by machine learning.

When the post-predicted value y\hat{ }^{p}ᵢ is input from the estimation unit 11, the search unit 12 compares the pre-predicted value y^{p}ᵢ with the post-predicted value y\hat{ }^{p}ᵢ. Specifically, the search unit 12 calculates a difference |y^{p}ᵢ−y\hat{ }^{p}ᵢ| between the pre-predicted value y^{p}ᵢ and the post-predicted value y\hat{ }^{p}ᵢ. The search unit 12 determines whether or not the calculated difference is less than a threshold value k set in advance, that is, whether or not |y^{p}ᵢ−y\hat{ }^{p}ᵢ|<k is satisfied. The threshold value k is a value that allows the pre-predicted value y^{p}ᵢ and the post-predicted value y\hat{ }^{p}ᵢ to be considered to be the same value in searching for the degree of congestion. When the difference is less than the threshold value k, the search unit 12 sets the final predicted value y^{p}_{fin}=the pre-predicted value y^{p}ᵢ, and outputs the final predicted value y^{p}_{fin} as information indicating the search result.

When the difference is not less than the threshold value k, the search unit 12 sets the next pre-predicted value y^{p}ᵢ. The search unit 12 sets the next pre-predicted value y^{p}ᵢ so that the difference between the pre-predicted value y^{p}ᵢ and the post-predicted value y\hat{ }^{p}ᵢ decreases. However, in the next estimation by the estimation unit 11 using the next pre-predicted value y^{p}ᵢ, the difference between the pre-predicted value y^{p}ᵢ and the post-predicted value y\hat{ }^{p}ᵢ does not necessarily need to decrease. For example, the search unit 12 sets the next pre-predicted value y^{p}ᵢ by an optimization method using an evaluation function (objective function) f based on the pre-predicted value y^{p}ᵢ and the post-predicted value y\hat{ }^{p}ᵢ. Specifically, the next pre-predicted value y^{p}ᵢ is set (searched for) using a gradient method. As the evaluation function f in this case, the following function is used.

$$f = ( 1 / 2 ) {( {y}^{{p}_{i}} - {y}^{∧ {p}_{i}} )}^{2}$$

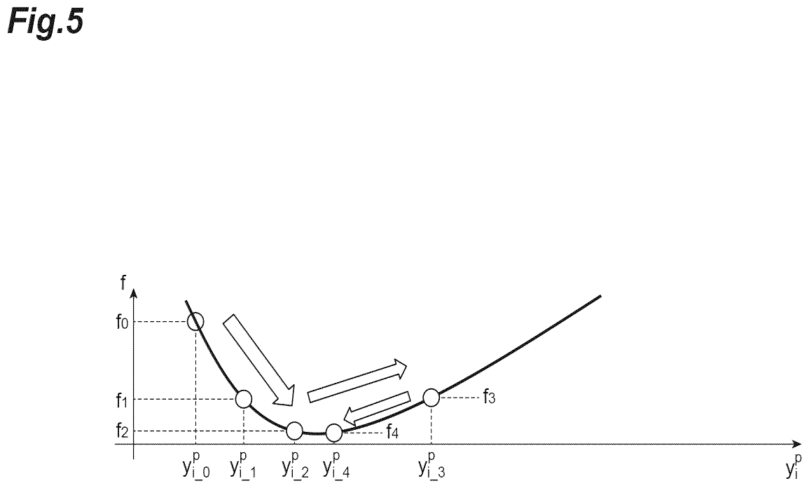

FIG. 5 shows an image of setting the next pre-predicted value y^{p}ᵢ (setting the pre-predicted value y^{p}ᵢ) using the gradient method. FIG. 5 shows the relationship between a pre-predicted value y^{p}ᵢn (horizontal axis) and a value fₙ (vertical axis) of the evaluation function. n indicates the number of times the pre-predicted value y^{p}ᵢ is set. y^{p}_{i_0} is the pre-predicted value y^{p}ᵢ that is set initially, and y^{p}_{i_1} is the pre-predicted value y^{p}ᵢ that is set after a simulation performed under the conditions in which information according to the degree of congestion is presented for the first time by the estimation unit 11. f₀ is a value of the evaluation function calculated using the pre-predicted value y^{p}_{i_0}, and f₁ is a value of the evaluation function calculated using the pre-predicted value y^{p}_{i_1}.

As shown in FIG. 5, in the gradient method, the value f of the current evaluation function is compared with the value f of the previous evaluation function, and the search for the next pre-predicted value y^{p}ᵢ proceeds in a direction in which the value f of the evaluation function decreases. In addition, since there is no value f of the evaluation function before f₀, when determining y^{p}_{i_1}, a search is performed in a direction set in advance or a random direction. As shown in FIG. 5, by repeatedly setting the next pre-predicted value y^{p}ᵢ in this manner, the value of the calculated evaluation function f also decreases. As a result, the difference |y^{p}ᵢ−y\hat{ }^{p}ᵢ| between the pre-predicted value y^{p}ᵢ and the post-predicted value y\hat{ }^{p}ᵢ also decreases.

In addition, the next pre-predicted value y^{p}ᵢ may be set by using an optimization method other than the gradient method. In addition, if the final predicted value y^{p}_{fin} can be searched for so that the difference between the pre-predicted value y^{p}ᵢ and the post-predicted value y\hat{ }^{p}ᵢ decreases by repeating the estimation by the estimation unit 11, the next pre-predicted value y^{p}ᵢ may be set by using a method other than the optimization method.

The search unit 12 repeatedly sets the next pre-predicted value y^{p}ᵢ and causes the estimation unit 11 to estimate the post-predicted value y\hat{ }^{p}ᵢ using the pre-predicted value y^{p}ᵢ until the difference |y^{p}ᵢ−y\hat{ }^{p}ᵢ| between the pre-predicted value y^{p}ᵢ and the post-predicted value y\hat{ }^{p}ᵢ becomes less than the threshold value k. In addition, when there are a plurality of targets for which the pre-predicted value y^{p}ᵢ is set and the post-predicted value y\hat{ }^{p}ᵢ is estimated, it is not necessary to search for the final predicted value y^{p}_{fin} for all of the targets, and the final predicted value y^{p}_{fin} may be searched for any of the targets.

Once the final predicted value y^{p}_{fin} is obtained, the search unit 12 outputs information indicating the final predicted value y^{p}_{fin} as information indicating the search result. For example, the search unit 12 may display the information on a display device provided in the congestion degree search system 10. Alternatively, the search unit 12 may transmit the information to another device, for example, a terminal of a person who acts in a behavior area including the target of the degree of congestion (that is, a person who is likely to go to the target). In addition, the search unit 12 may output the information in a method other than the above.

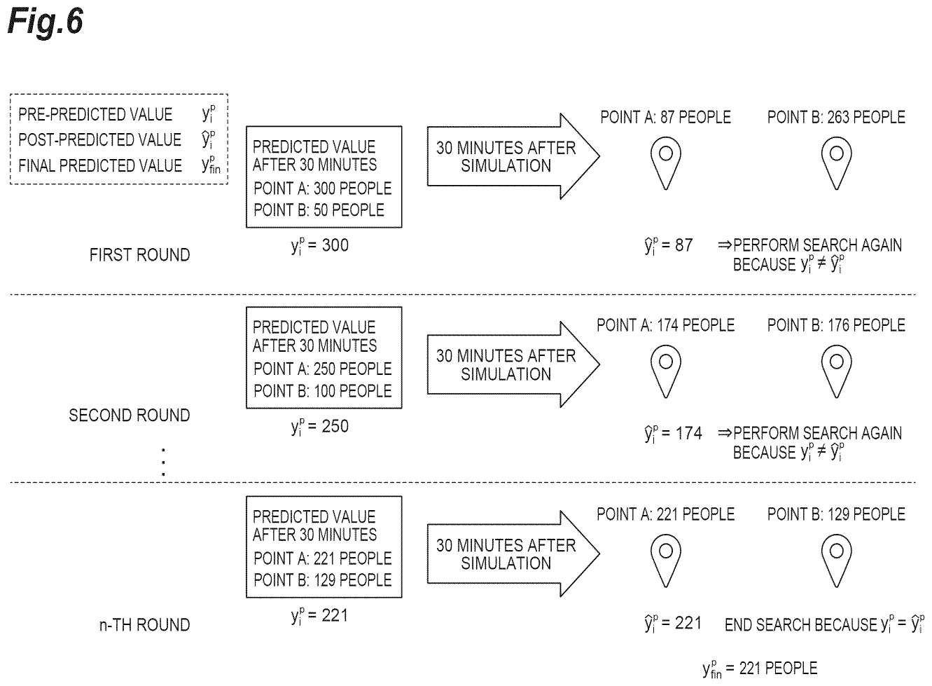

Here, a specific example of searching for the final predicted value y^{p}_{fin} will be shown with reference to FIG. 6. In the example of FIG. 6, for two targets at points A and B, a pre-predicted value y^{p}ᵢ is set and a post-predicted value y\hat{ }^{p}ᵢ is estimated, and for the point A, a final predicted value y^{p}_{fin} is searched for.

In the first round of the search, the pre-predicted value y^{p}ᵢ is set to 300 people for the point A and 50 people for the point B. In the first round of the search, as described above, the pre-predicted value y^{p}ᵢ is generated by estimation by the estimation unit 11 under the conditions in which information according to the degree of congestion is not presented to people who act or by a method using a learning model generated by machine learning. As simulation results by the estimation unit 11, the post-predicted value y\hat{ }^{p}ᵢ for the point A is 87 people, and the post-predicted value y\hat{ }^{p}ᵢ for the point B is 263 people. At the point A, the difference |y^{p}ᵢ−y\hat{ }^{p}ᵢ| between the pre-predicted value y^{p}ᵢ and the post-predicted value y\hat{ }^{p}ᵢ becomes equal to or greater than the threshold value k (that is, y^{p}ᵢ≠y\hat{ }^{p}ᵢ), and accordingly, the search is performed again.

In the second and subsequent rounds of the search, the pre-predicted value y^{p}ᵢ is set by the gradient method or the like as described above. In the second round of the search, the pre-predicted value y^{p}ᵢ is set to 250 people for the point A and 100 people for the point B. As simulation results by the estimation unit 11, the post-predicted value y\hat{ }^{p}ᵢ for the point A is 174 people, and the post-predicted value y\hat{ }^{p}ᵢ for the point B is 176 people. At the point A, the difference |y^{p}ᵢ−y\hat{ }^{p}ᵢ| between the pre-predicted value y^{p}ᵢ and the post-predicted value y\hat{ }^{p}ᵢ becomes equal to or greater than the threshold value k (that is, y^{p}ᵢ≠y\hat{ }^{p}ᵢ), and accordingly, the search is performed again.

The above search is repeatedly performed. In the n-th round of the search, the pre-predicted value y″; is set to 221 people for the point A and 129 people for the point B. As simulation results by the estimation unit 11, the post-predicted value y\hat{ }^{p}ᵢ for the point A is 221 people, and the post-predicted value y\hat{ }^{p}ᵢ for the point B is 129 people. At the point A, the difference |y^{p}ᵢ−y\hat{ }^{p}ᵢ| between the pre-predicted value y^{p}ᵢ and the post-predicted value y\hat{ }^{p}ᵢ becomes less than the threshold value k (here, y^{p}ᵢ=y\hat{ }^{p}ᵢ), and accordingly, the final predicted value y^{p}_{fin} for the point A is set to 221 people and the search ends. The above is the function of the congestion degree search system 10 according to the present embodiment.

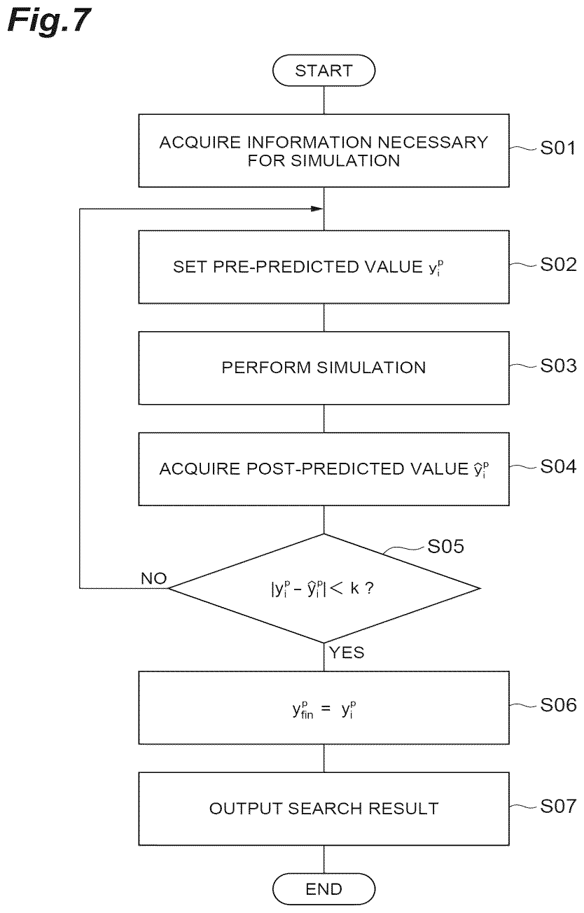

Subsequently, a process performed by the congestion degree search system 10 according to the present embodiment (a method of an operation performed by the congestion degree search system 10) will be described with reference to the flowchart of FIG. 7. In this process, first, the estimation unit 11 acquires information necessary for the simulation (S01). In addition, the search unit 12 sets the pre-predicted value y^{p}ᵢ that is the degree of congestion used for estimation by the estimation unit 11 (S02). Then, the estimation unit 11 performs a simulation of people's behavior under the conditions, in which information corresponding to the degree of congestion set in advance for the target is presented to people who act, using the acquired information and the set pre-predicted value y^{p}ᵢ (S03). The estimation unit 11 acquires the post-predicted value y\hat{ }^{p}ᵢ that is the degree of congestion of the target based on the simulation result (S04).

Then, the search unit 12 determines whether or not the difference |y^{p}ᵢ−y\hat{ }^{p}ᵢ| between the pre-predicted value y^{p}ᵢ and the post-predicted value y\hat{ }^{p}ᵢ is less than the threshold value k (S05). When it is determined that |y^{p}ᵢ−y\hat{ }^{p}ᵢ|<k is not satisfied (NO in S05), the search unit 12 sets the pre-predicted value y^{p}ᵢ again (S02). The re-setting of the pre-predicted value y^{p}ᵢ is performed so that the difference between the pre-predicted value y^{p}ᵢ and the post-predicted value y\hat{ }^{p}ᵢ decreases. Therefore, for the re-setting of the pre-predicted value y^{p}ᵢ, a gradient method and the like may be used. Then, the above-described steps S03 to S05 are repeated using the set pre-predicted value y^{p}ᵢ.

When it is determined that |y^{p}ᵢ-y\hat{ }^{p}ᵢ|<k is satisfied in S05 (YES in S05), the search unit 12 sets the pre-predicted value y^{p}ᵢ at that time as the final predicted value y^{p}_{fin} as a result of the search for the degree of congestion (S06). Then, the search unit 12 outputs information indicating the final predicted value y^{p}_{fin} that is the result of the search for the degree of congestion (S07). The above is the process performed by the congestion degree search system 10 according to the present embodiment.

In the present embodiment, under the conditions in which information according to the pre-predicted value y^{p}ᵢ is presented to people who act, the post-predicted value y\hat{ }^{p}ᵢ is estimated, and the degree of congestion is searched for so that the difference between the pre-predicted value y^{p}ᵢ and the post-predicted value y\hat{ }^{p}ᵢ decreases. Therefore, according to the present embodiment, it is possible to search for the final predicted value y^{p}_{fin} that is the appropriate degree of congestion when people to whom information according to the degree of congestion is presented change their behavior. As a result, it is possible to grasp the accurate degree of congestion under the above conditions, and for example, take appropriate measures according to the degree of congestion.

In addition, as in the present embodiment, the pre-predicted value y^{p}ᵢ used in the next estimation by the estimation unit 11 may be set by an optimization method using an evaluation function based on the pre-predicted value y^{p}ᵢ and the post-predicted value y\hat{ }^{p}ᵢ, for example, by a gradient method. According to this configuration, the final predicted value y^{p}_{fin} can be searched for appropriately and reliably. However, the setting of the pre-predicted value y^{p}ᵢ used for the next estimation by the estimation unit 11 does not have to be performed as described above, and may be performed using a method other than the above as long as it is possible to search for the final predicted value y^{p}_{fin}.

In addition, as in the present embodiment, the post-predicted value y\hat{ }^{p}ᵢ may be estimated by simulating people's behavior under the conditions in which information according to the pre-predicted value y^{p}ᵢ is presented to people who act. In addition, the behavior of each person may be simulated under the conditions in which information according to the pre-predicted value y^{p}ᵢ is presented to people who act. For example, a multi-agent simulation may be performed as described above. According to this configuration, an appropriate simulation can be performed, and as a result, an appropriate final predicted value y^{p}_{fin} can be searched for. However, the simulation does not necessarily have to be a simulation of the behavior of each person, and any simulation may be performed as long as the post-predicted value y\hat{ }^{p}ᵢ is obtained as simulation results. In addition, the post-predicted value y\hat{ }^{p}ᵢ may be estimated using a method other than simulating people's behavior.

In addition, the block diagrams used in the description of the above embodiment show blocks in functional units. These functional blocks (components) are realized by any combination of at least one of hardware and software. In addition, a method of realizing each functional block is not particularly limited. That is, each functional block may be realized using one physically or logically coupled device, or may be realized by connecting two or more physically or logically separated devices directly or indirectly (for example, using a wired or wireless connection) and using the plurality of devices. Each functional block may be realized by combining the above-described one device or the above-described plurality of devices with software.

Functions include determining, judging, calculating, computing, processing, deriving, investigating, searching, ascertaining, receiving, transmitting, outputting, accessing, resolving, selecting, choosing, establishing, comparing, assuming, expecting, regarding, broadcasting, notifying, communicating, forwarding, configuring, reconfiguring, allocating, mapping, assigning, and the like, but are not limited thereto. For example, a functional block (configuration unit) that makes the transmission work is called a transmitting unit or a transmitter. In any case, as described above, the implementation method is not particularly limited.

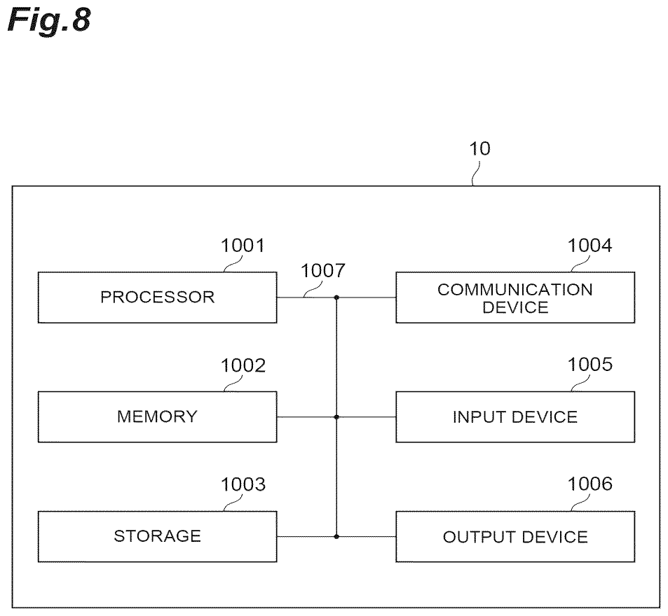

For example, the congestion degree search system 10 according to an embodiment of the present disclosure may function as a computer that performs information processing of the present disclosure. FIG. 8 is a diagram showing an example of the hardware configuration of the congestion degree search system 10 according to an embodiment of the present disclosure. The congestion degree search system 10 described above may be physically configured as a computer device including a processor 1001, a memory 1002, a storage 1003, a communication device 1004, an input device 1005, an output device 1006, a bus 1007, and the like.

In addition, in the following description, the term “device” can be read as a circuit, a unit, and the like. The hardware configuration of the congestion degree search system 10 may include one or more devices for each of the devices shown in the diagram, or may not include some devices.

Each function in the congestion degree search system 10 is realized by reading predetermined software (program) onto hardware, such as the processor 1001 and the memory 1002, so that the processor 1001 performs an operation and controlling communication by the communication device 1004 or controlling at least one of reading and writing of data in the memory 1002 and the storage 1003.

The processor 1001 controls the entire computer by operating an operating system, for example. The processor 1001 may be configured by a central processing unit (CPU) including an interface with a peripheral device, a control device, an operation device, a register, and the like. For example, each function in the congestion degree search system 10 described above may be realized by the processor 1001.

In addition, the processor 1001 reads a program (program code), a software module, data, and the like into the memory 1002 from at least one of the storage 1003 and the communication device 1004, and executes various kinds of processing according to these. As the program, a program causing a computer to execute at least a part of the operation described in the above embodiment is used. For example, each function in the congestion degree search system 10 may be realized by a control program that is stored in the memory 1002 and operates in the processor 1001. Although it has been described that the various kinds of processes described above are performed by one processor 1001, the various kinds of processes described above may be performed simultaneously or sequentially by two or more processors 1001. The processor 1001 may be implemented by one or more chips. In addition, the program may be transmitted from a network through a telecommunication line.

The memory 1002 is a computer-readable recording medium, and may be configured by at least one of, for example, a ROM (Read Only Memory), an EPROM (Erasable Programmable ROM), an EEPROM (Electrically Erasable Programmable ROM), and a RAM (Random Access Memory). The memory 1002 may be called a register, a cache, a main memory (main storage device), and the like. The memory 1002 can store a program (program code), a software module, and the like that can be executed to perform the information processing according to an embodiment of the present disclosure.

The storage 1003 is a computer-readable recording medium, and may be configured by at least one of, for example, an optical disk such as a CD-ROM (Compact Disc ROM), a hard disk drive, a flexible disk, and a magneto-optical disk (for example, a compact disk, a digital versatile disk, and a Blu-ray (Registered trademark) disk), a smart card, a flash memory (for example, a card, a stick, a key drive), a floppy (registered trademark) disk, and a magnetic strip. The storage 1003 may be called an auxiliary storage device. The storage medium provided in the congestion degree search system 10 may be, for example, a database including at least one of the memory 1002 and the storage 1003, a server, or other appropriate media.

The communication device 1004 is hardware (transmitting and receiving device) for performing communication between computers through at least one of a wired network and a radio network, and is also referred to as, for example, a network device, a network controller, a network card, and a communication module.

The input device 1005 is an input device (for example, a keyboard, a mouse, a microphone, a switch, a button, and a sensor) for receiving an input from the outside. The output device 1006 is an output device (for example, a display, a speaker, and an LED lamp) that performs output to the outside. In addition, the input device 1005 and the output device 1006 may be integrated (for example, a touch panel).

In addition, respective devices, such as the processor 1001 and the memory 1002, are connected to each other by the bus 1007 for communicating information. The bus 1007 may be configured using a single bus, or may be configured using a different bus for each device.

In addition, the congestion degree search system 10 may include hardware, such as a microprocessor, a digital signal processor (DSP), an ASIC (Application Specific Integrated Circuit), a PLD (Programmable Logic Device), and an FPGA (Field Programmable Gate Array), and some or all of the functional blocks may be realized by the hardware. For example, the processor 1001 may be implemented by using at least one of these hardware components.

In the processing procedure, sequence, flowchart, and the like in each aspect/embodiment described in the present disclosure, the order may be changed as long as there is no contradiction. For example, for the methods described in the present disclosure, elements of various steps are presented using an exemplary order. However, the present invention is not limited to the specific order presented.

Information or the like that is input and output may be stored in a specific place (for example, a memory) or may be managed using a management table. The information or the like that is input and output can be overwritten, updated, or added. The information or the like that is output may be deleted. The information or the like that is input may be transmitted to another device.

The judging may be performed based on a value (0 or 1) expressed by 1 bit, may be performed based on the Boolean value (Boolean: true or false), or may be performed by numerical value comparison (for example, comparison with a predetermined value).

Each aspect/embodiment described in the present disclosure may be used alone, may be used in combination, or may be switched and used according to execution. In addition, the notification of predetermined information (for example, notification of “X”) is not limited to being explicitly performed, and may be performed implicitly (for example, without the notification of the predetermined information).

While the present disclosure has been described in detail, it is apparent to those skilled in the art that the present disclosure is not limited to the embodiments described in the present disclosure. The present disclosure can be implemented as modified and changed aspects without departing from the spirit and scope of the present disclosure defined by the description of the claims. Therefore, the description of the present disclosure is intended for illustrative purposes, and has no restrictive meaning to the present disclosure.

Software, regardless of whether this is called software, firmware, middleware, microcode, a hardware description language, or any other name, should be interpreted broadly to mean instructions, instruction sets, codes, code segments, program codes, programs, subprograms, software modules, applications, software applications, software packages, routines, subroutines, objects, executable files, execution threads, procedures, functions, and the like.

In addition, software, instructions, information, and the like may be transmitted and received through a transmission medium. For example, in a case where software is transmitted from a website, a server, or other remote sources using at least one of the wired technology (coaxial cable, optical fiber cable, twisted pair, digital subscriber line (DSL), and the like) and the wireless technology (infrared, microwave, and the like), at least one of the wired technology and the wireless technology is included within the definition of the transmission medium.

The terms “system” and “network” used in the present disclosure are used interchangeably.

In addition, the information, parameters, and the like described in the present disclosure may be expressed using an absolute value, may be expressed using a relative value from a predetermined value, or may be expressed using another corresponding information.

The term “determining” used in the present disclosure may involve a wide variety of operations. For example, “determining” can include considering judging, calculating, computing, processing, deriving, investigating, looking up, searching, inquiring (for example, looking up in a table, database, or another data structure), and ascertaining as “determining”. In addition, “determining” can include considering receiving (for example, receiving information), transmitting (for example, transmitting information), inputting, outputting, and accessing (for example, accessing data in a memory) as “determining”. In addition, “determining” can include considering resolving, selecting, choosing, establishing, comparing, and the like as “determining”. That is, “determining” can include considering any operation as “determining”. In addition, “determining” may be read as “assuming”, “expecting”, “considering”, and the like.

The terms “connected” and “coupled” or variations thereof mean any direct or indirect connection or coupling between two or more elements, and can include a case where one or more intermediate elements are present between two elements “connected” or “coupled” to each other. The coupling or connection between elements may be physical, logical, or a combination thereof. For example, “connection” may be read as “access”. When used in the present disclosure, two elements can be considered to be “connected” or “coupled” to each other using at least one of one or more wires, cables, and printed electrical connections and using some non-limiting and non-inclusive examples, such as electromagnetic energy having wavelengths in a radio frequency domain, a microwave domain, and a light (both visible and invisible) domain.

The description “based on” used in the present disclosure does not mean “based only on” unless otherwise specified. In other words, the description “based on” means both “based only on” and “based at least on”.

Any reference to elements using designations such as “first” and “second” used in the present disclosure does not generally limit the quantity or order of the elements. These designations can be used in the present disclosure as a convenient method for distinguishing between two or more elements. Therefore, references to first and second elements do not mean that only two elements can be adopted or that the first element should precede the second element in any way.

When “include”, “including”, and variations thereof are used in the present disclosure, these terms are intended to be inclusive similarly to the term “comprising”. In addition, the term “or” used in the present disclosure is intended not to be an exclusive-OR.

In the present disclosure, in a case where articles, for example, a, an, and the in English, are added by translation, the present disclosure may include that nouns subsequent to these articles are plural.

In the present disclosure, the expression “A and B are different” may mean “A and B are different from each other”. In addition, the expression may mean that “A and B each are different from C”. Terms such as “separate” and “coupled” may be interpreted similarly to “different”.

The congestion degree search system of the present disclosure has the following configuration.

[1] A congestion degree search system for searching for, for a target of a degree of congestion that is a location or a transportation means, a degree of congestion of the target when people change their behavior in response to information according to a degree of congestion being presented, the system including: an estimation unit that estimates the degree of congestion of the target under conditions in which information according to a degree of congestion set in advance for the target is presented to people who act; and a search unit that sets a degree of congestion used in estimation by the estimation unit, causes the estimation unit to repeatedly estimate the degree of congestion, and searches for the degree of congestion of the target so that a difference between the degree of congestion used in the estimation by the estimation unit and the degree of congestion estimated by the estimation unit decreases.

[2] The congestion degree search system according to [1], wherein the search unit sets a degree of congestion used in next estimation by the estimation unit by using an optimization method using an evaluation function based on the degree of congestion used in the estimation by the estimation unit and the degree of congestion estimated by the estimation unit.

[3] The congestion degree search system according to [1] or [2], wherein the estimation unit estimates the degree of congestion of the target by simulating people's behavior under the conditions in which information according to the degree of congestion set in advance for the target is presented to people who act.

[4] The congestion degree search system according to claim [3], wherein the estimation unit simulates behavior of each person under the conditions in which information according to the degree of congestion set in advance for the target is presented to people who act.

### REFERENCE SIGNS LIST

10: congestion degree search system, 11: estimation unit, 12: search unit, 1001: processor, 1002: memory, 1003: storage, 1004: communication device, 1005: input device, 1006: output device, 1007: bus.

1. A congestion degree search system for searching for, for a target of a degree of congestion that is a location or a transportation means, a degree of congestion of the target when people change their behavior in response to information according to a degree of congestion being presented, the system comprising circuitry configured to:
estimate the degree of congestion of the target under conditions in which information according to a degree of congestion set in advance for the target is presented to people who act; and
set a degree of congestion used in estimation, repeatedly estimate the degree of congestion, and searches for the degree of congestion of the target so that a difference between the degree of congestion used in the estimation and the estimated degree of congestion.

2. The congestion degree search system according to claim 1,
wherein the circuitry sets a degree of congestion used in next estimation by using an optimization method using an evaluation function based on the degree of congestion used in the estimation and the estimated degree of congestion.

3. The congestion degree search system according to claim 1,
wherein the circuitry estimates the degree of congestion of the target by simulating people's behavior under the conditions in which information according to the degree of congestion set in advance for the target is presented to people who act.

4. The congestion degree search system according to claim 3,
wherein the circuitry simulates behavior of each person under the conditions in which information according to the degree of congestion set in advance for the target is presented to people who act.
